(19) United States
(12) Patent Application Publication
(10) Pub. No.: US 2004/0249752 A1
(43) Pub. Date: Dec. 9, 2004

(54) Charity funding method using an open-ended stored-value card

(75) Inventors: Paul H. Prato, Newport Beach, CA (US); Gayla L. Sajben, Laguna Niguel, CA (US); June W. Chung, Brea, CA (US); Erin M. Pedersen, Newport Beach, CA (US); Dawn E. Winship, Costa Mesa, CA (US)

Correspondence Address: SUGHRUE MION, PLLC, 401 Castro Street, Ste 220, Mountain View, CA, 94041-2007, US

(73) Assignee: Impact Consulting & Management, Newport Beach, CA

(21) Appl. No.: 10/456,315

(22) Filed: Jun. 6, 2003

(51) Int. Cl. G06F 17/60

(52) U.S. Cl. 705/41

(57) ABSTRACT

A method enabling a prepaid, open-ended stored-value charity card used as a fundraising vehicle providing dollar-based monetary funding to pre-selected charities is disclosed. The method uses an existing prepaid, open-ended, stored-value card that relies upon credit card technology, and can be redeemed at any merchant accepting credit card transactions. A prepaid, open-ended, stored-value card has a defined value that may be used in multiple transactions or until the value is depleted. The stored-value card is distributed to pre-selected charities either directly from a Charity Card Provider, or through an intermediate Reseller, and further distributed to a user. The charity receives funds by either distributing the charity card to a user at a premium in addition to the face value, obtaining the charity card at a discount to the face value, or by having merchant sponsorships.

### BACKGROUND OF THE INVENTION

1. Field of the Invention

This invention relates to a method of charity funding as a benefit to charity supporters who purchase open-ended prepaid stored-value debit cards.

2. Description of the Related Art

There are known examples of prepaid cards for making purchases and donations to charities. For example, Fite et al., U.S. Pat. No. 6,467,684, describes a prepaid card for purchases using an electronic or computer network such as the Internet. The prepaid cards do not have a declining balance and are designed for one-time use only. According to a further aspect of the prepaid card, any difference between the cash value of a prepaid card and the purchase price can be credited to a general account at the host bank which may be used for any designated purpose, such as a donation to a host or customer or to a specified charity. Alternatively, the difference may be credited to a customer's account at the host bank. A charity may benefit when, and only when, the residual value of a prepaid card was designated to a charity.

In another system to benefit charities, Burke, U.S. Pat. No. 6,088,682, describes a system wherein a user has a donor card. A donor card has a magnetic strip containing identification numbers linking a user with a charity and can be read by typical point-of-sale terminals already present at retail locations. A user purchases goods for cash, and typically provides payment such that change is due. In lieu of receiving the change, the user may present the donor card and the donor card is read by the point-of-sale terminal. The user may then designate the amount of change to be donated to the charity and receive the remainder of the change.

In still another system to benefit charities, Hovakimian, U.S. Pat. No. 5,466,919, links a credit or debit card with one or more charities, wherein when a credit or debit card is used to make a purchase, a portion of the purchase price is added to the transaction and donated to the charities of the user's choice.

Visa™, MasterCard™, Discover™, and American Express™ open-ended, stored-value, prepaid gift cards are marketed today to consumers through businesses-to-consumers, and through business-to-business channels for employees, distributors, and customers. Typically, companies purchase such gift cards in bulk for distribution to their employees or customers as employee incentives, awards, customer incentives, promotional rewards, sales retention tools and customer loyalty benefits. In some cases, a discount may be offered to a corporation for large bulk purchases. In the consumer marketplace, card companies, as well as their distributors (banks, credit card issuers, financial institutions, etc.), often charge a premium to their customers in addition to the face value of gift cards purchased.

Over the course of the past 20 years, charities have identified and embarked on many channels, products and systems for enabling supporters to donate to their causes with cash, a percentage of sales on sponsored products, donated merchandise, airline miles, etc. One of these channels, the scrip methodology, was developed some 15 years ago by the grocery industry to entice charities such as schools to purchase their store gift certificates in bulk at a discount. The certificates were then resold to the charity supporters at face value for redemption at face value. The difference between the discounted cost and the face value was retained by the charity.

From the merchant's perspective, hundreds of brand establishments participate in various scrip channels through Scrip certificate clearinghouses, resellers, on-line credit card registration programs, etc. Most recent is a credit card program sponsored by a scrip institution that allows funding charities to receive an identified percentage of sale when users use the credit card at predetermined merchant establishments.

### SUMMARY OF THE INVENTION

The invention described herein, charity cards, are distributed to users through charities that obtain the charity cards directly from a Charity Card Provider or indirectly through a Reseller. The charity receives funds by either distributing the charity card to a user at a premium in addition to the face value, obtaining the charity card at a discount to the face value, or by having merchant sponsorships.

The charity card, a novel open-ended, stored-value, prepaid card distributed through charities, has a number of attributes. First, the charity card itself is a stored-value card, which means that it is pre-loaded with an exact value, issued by a branded card system. Second, the charity card is an open-ended credit card product that allows it to be used at any of the merchants in the world that accept the branded credit card for products or services rendered. The card itself can be used to make purchases at a merchant's location, via the Internet, or via a telephone. Simply, a merchant accepts the card as payment like any credit or debit card today. The purchase transaction takes place using a merchant's standard process for accepting credit or debit cards. The transaction itself travels via the merchant point-of-sale (POS) to a credit card processor, to the bank's settling processor, back through the credit card processor to the merchant POS. This entire process may take less than 5 seconds and is completed with the verification of funds on the card as well as the merchant location. The merchant POS system provides the sales person with instructions to approve or decline the purchase, as with any other credit card processing system, and the user, if applicable, signs the receipt in exchange for the merchandise or service. The value is immediately decremented from the overall remaining value of the card down to the exact penny. The user may make a purchase for more than the value remaining on the card by providing a supplemental form of payment at the merchant location as allowed by the merchant's policies. For example, the user has the responsibility of outlining the payment options and exact dollar values to be input for the transaction. To further illustrate this example, merchandise costing $125.50 may be paid using a $100 charity card and $25.50 in cash.

The charity card may also be used in a commercial promotion where a product company or retailer wants to promote a product or increase the loyalty among product users. For instance, a specific retailer may have interest in customizing the charity card with its own merchant name and logo. While the card itself can be used at any participating merchant worldwide (based on the sponsored credit card brand), the strong influence from the logo, name depiction and association will have an impact on the merchant's market share of use stemming from this particular segment of cards. User behavior and spending patterns are altered through this association and as a result, the user's frequency and loyalty to a particular merchant brand is increased. Finally, users use the cards for goods and/or services for the cash value associated with the card until the card balance is depleted. Some users may not use the entire value placed on the card.

Within a time specified and embossed on the face of the card, the card will expire allowing no further purchases regardless of the remaining balance. At this point, a user has a grace period to take further action. First, if left abandoned with no action and the grace period has expired, the remaining balance on the card will be assumed by the Charity Card Provider and deposited into a bank account to be used to offset program management costs. Second, within the grace period, the user can have the card reissued with a new expiration date and the remaining value will be carried over to the new card. Lastly, using the Internet or some other communications means, the user can transfer the remaining balance to a charity organization of the user's choice including the sponsoring charity under which the card was originally issued.

A user may create a profile using the Charity Card Provider's available customer support resources for registering all the charity cards that the user purchases. The user profile will comprise the user's personal information including a security identification, and detailed account information including issuing charities, value of the charity cards, purchase information for the charity cards, and dates. The user can then request a report of charity card activity, and the report may then be used, but not limited to, documenting charitable donations.

### BRIEF DESCRIPTION OF THE DRAWINGS

These and other features and benefits of the invention will be readily appreciated in light of the following detailed description of the preferred embodiments thereof, given by way of example only with reference to the accompanying drawings wherein:

FIG. 1 is a diagram showing the relationships and information flows among the various participants in the charity card method and the system wherein the Charity Card Provider provides services to the Charities through Resellers.

FIG. 2 is a diagram showing the relationships and information flows among the various participants in the charity card method and system wherein the Charity Card Provider provides services directly to the Charities.

FIGS. 3A and 3B are a flow diagram depicting information flow from a Charity Card Provider through a Reseller and a Charity to a user.

FIGS. 4A and 4B are a flow diagram depicting information flow from a Charity Card Provider through a Charity to a user.

FIG. 5 is a flowchart showing how the remaining value of an expired charity card can be used.

FIG. 6 shows a process for creating a detailed report itemizing a user's charitable contributions.

FIG. 7 shows a process for merchants to contribute additional funds directly to charities or to offset charity card expenses.

FIG. 8 shows the data flow from the charity card to the host provider and issuing bank.

FIG. 9 shows one embodiment of data flow from a charity card user to the charity card provider.

### DETAILED DESCRIPTION OF THE PREFERRED EMBODIMENTS

Preferred embodiments of the present invention will now be described with reference to the attached drawings, wherein identical elements are designated with like numerals.

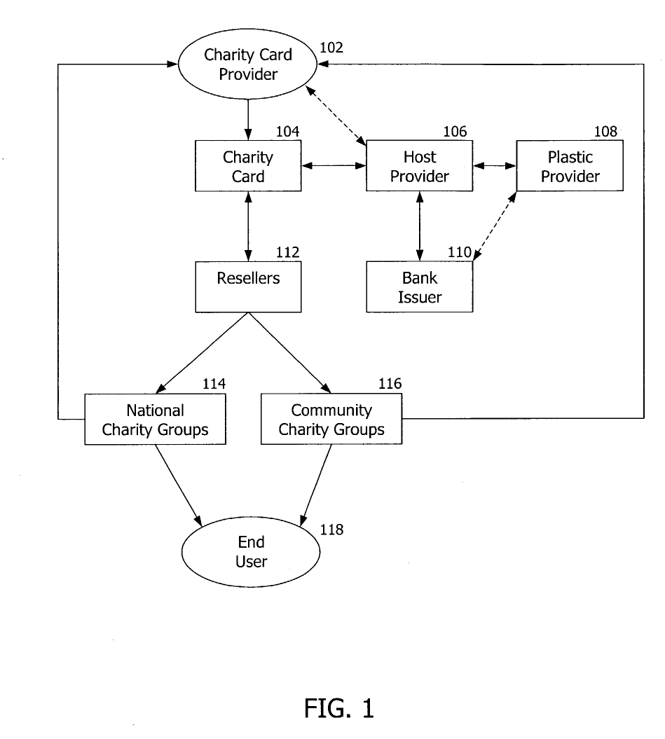

FIG. 1 provides a flow chart showing the relationships among the participants in the charity card system. This chart reflects the entire process of providing a charity card to a user and providing funds to a Charity using Resellers 112. A Reseller is a designated and approved company or individual authorized to provide charity cards on behalf of the Charity Card Provider 102. The Charity Card Provider 102 establishes relationships and accounting channels to a host provider 106 thereby obtaining a branded prepaid stored-value charity card 104 from an issuing bank 110 and a plastic provider 108. A plastic provider is authorized by the issuing bank 110 to supply the actual card plates. The host provider 106 is the system, company or individual, or combination thereof, which hosts the base processing system. The issuing bank 110 is a bank or other financial institution having the authority to issue credit, debit, or prepaid cards branded by local, national, or international systems, such as, but not limited to, VISA™, MasterCard™, EuroCard™, Discover™, or American Express™. The charity card is then provided to Resellers 112 for further distribution to Charities 114 and 116 and then to the ultimate end users 118.

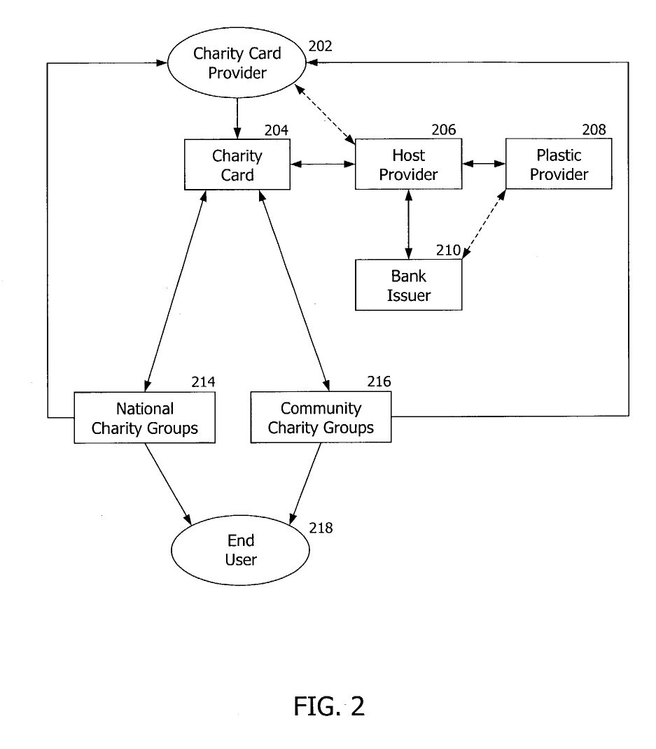

FIG. 2 displays a similar method wherein charity cards are distributed directly to Charities 214 and 216 by the Charity Card Provider 202.

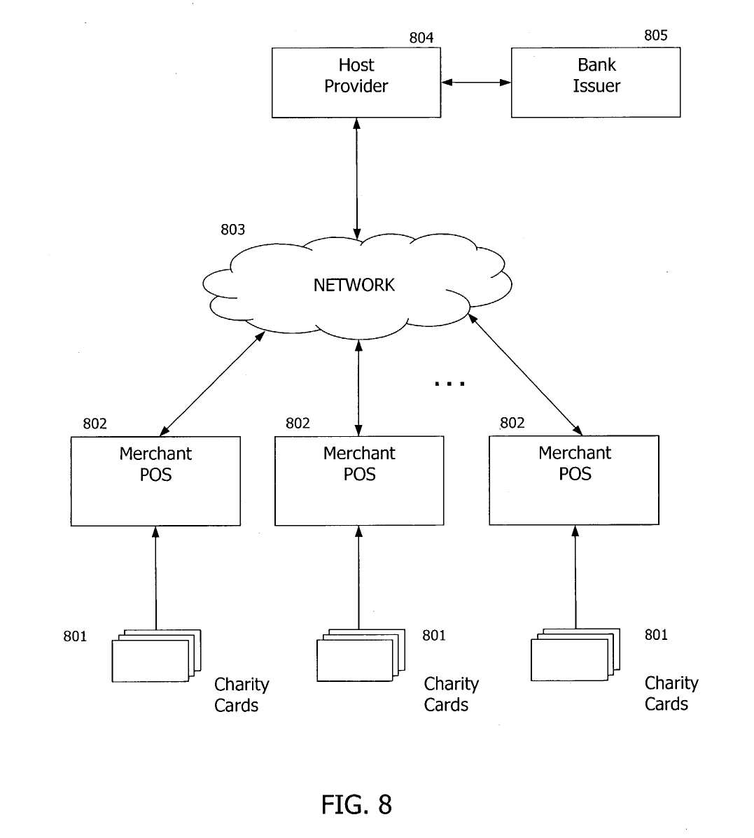

Referring now to FIG. 8, the charity cards 801 may be used at a merchant authorized to accept branded credit cards. Data from the charity card and details of the purchase are recorded at the merchant's point-of-sale (POS) terminal, and the data is transmitted over a network 803 connecting the merchant to a host provider 804 that processes the transaction. The host provider 804 is connected to the issuing bank 805 or other financial institution that authorizes the transaction. Upon communicating with the issuing bank 805 or other financial institution, the host provider 804 will accept or decline the transaction and will display the appropriate instructions on the merchant POS 801. The merchant will then process the purchase according to the instructions received from the host provider.

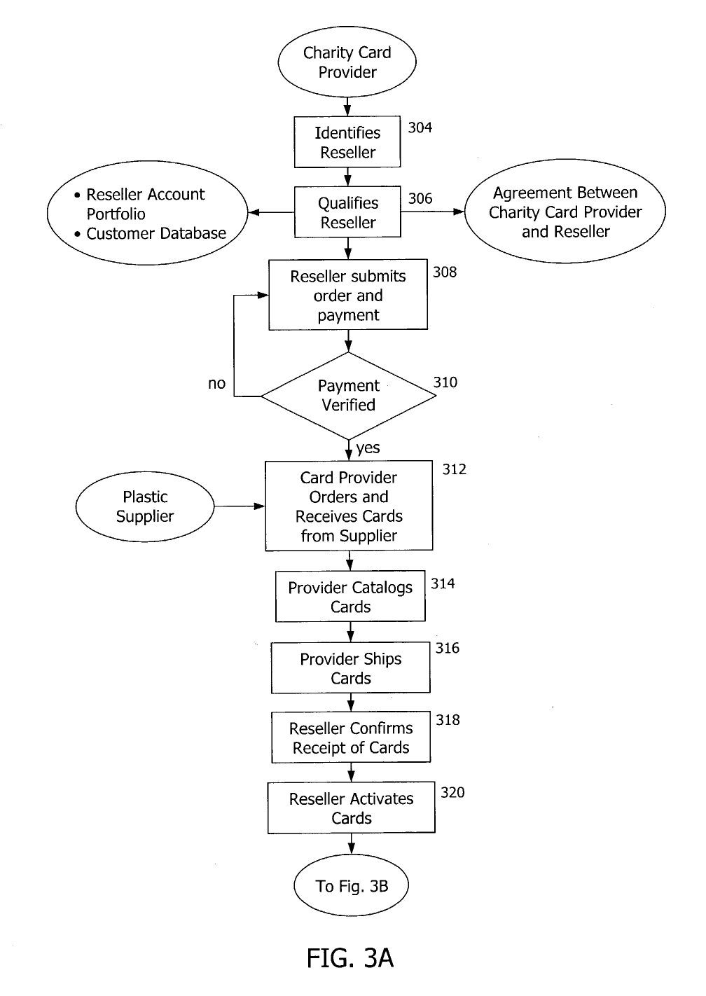

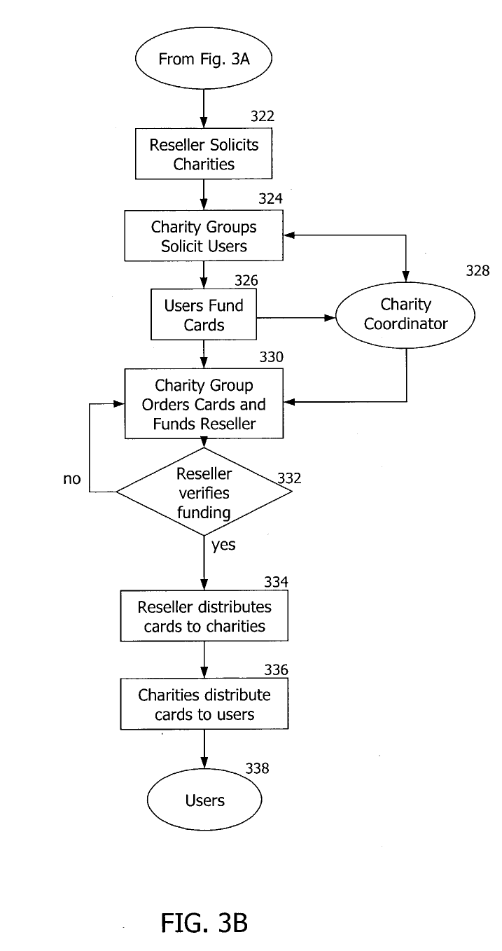

Referring to FIG. 3, the charity card process from Reseller to the end user begins when the Charity Card Provider identifies a Reseller [step 304] to purchase and market the charity card. Upon qualification of the Reseller [step 306], a purchase agreement is implemented and appropriate seller account portfolios and customer databases are established. Once the purchase agreement is finalized, the Reseller submits an order in detail including the exact quantity and denominations of charity cards needed for inventory [step 308]. Once payment is received and verified [step 310], the Charity Card Provider processes the order electronically in the fulfillment system [step 312].

Charity cards are received from the supplier and may be embossed to identify a particular charity or merchant as needed, electronically catalogued [step 314], and shipped to the Reseller [step 316]. Each card carries a unique 16-digit number that is catalogued electronically as “pending issuance” in the fulfillment system. The charity cards can either be batch activated immediately, batch activated on delay (i.e. to activate 24-hours later) or flagged as “held” until the Purchasing Group calls or electronically confirms receipt. Upon receipt confirmation [step 318], the cards are activated [step 320].

Upon receipt, the Reseller places the already activated charity cards in their inventory and may begin marketing to their Charities [step 322]. Charities can market the charity card in one of two ways: 1) purchased in advance as standard stock and fulfilled from inventory; or 2) purchased on demand by individual supporter orders [step 324]. Typically, supporter orders are placed and payments are made [step 326] through a central organization or Charity Coordinator 328 then, the Charity submits order and payment to the Reseller [step 330]. In some charities, a single individual or a small staff may serve as a Charity Coordinator. In larger charities, a department having other responsibilities may perform the Charity Coordinator function. In either case, the Charity Coordinator will use traditional methods such as personal contact, telephone communications, and maintaining Web sites to solicit and provide services to the charity card users.

Once payment is verified [step 332], the Charity receives the cards [step 334] and redistributes the cards to the users [step 336]. The final step is for the user 338 to redeem the card. Once received, the cards become the property of the user and may be used at any merchant worldwide who accepts the branded card.

The Charity also keeps detailed records of individual purchases of charity cards to track the funding represented by an individual, a family and group as a whole. Such records may also be used to trace cards by number for auditing as necessary.

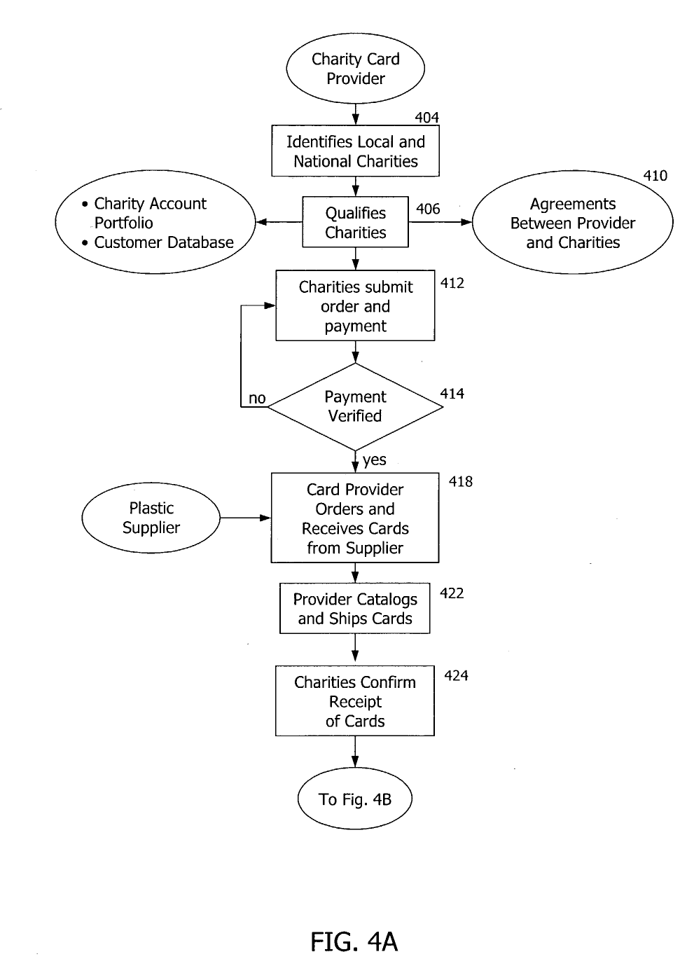

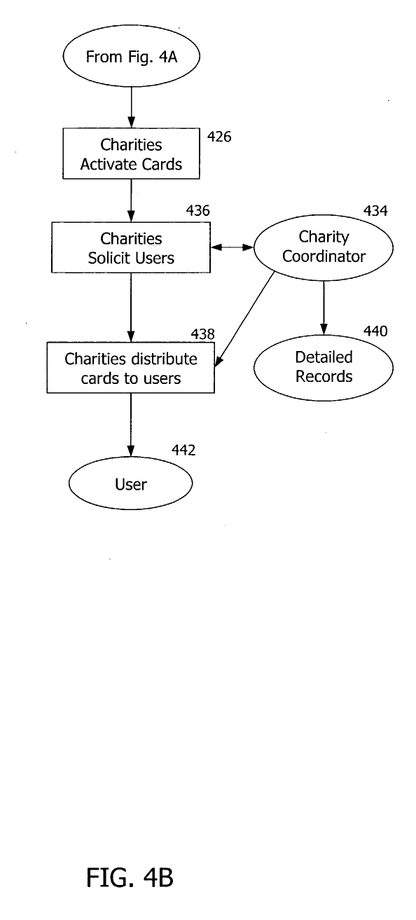

The charity cards may be provided directly to charities in a similar manner. Referring to FIGS. 4A and 4B, the charity card process from either a National or Community Charity to End-User begins when the Charity Card Provider has identified charities [step 404] interested in gaining donations by distributing the charity cards. Upon meeting the application requirements to purchase the charity cards [step 406], the qualified Charity secures a purchasing agreement. Once the application is complete, the Charity Card Provider stores payment information and other pertinent and identifying details in the Charity Account Portfolio within the Customer Databank. The Charity then submits an order in detail including the exact quantity and denominations of charity cards needed for inventory [step 412]. Once payment is received and verified, the Charity Card Provider processes the order electronically in the fulfillment system [step 414].

Charity cards are requested from the supplier [step 418], embossed as needed, electronically catalogued, and shipped [step 422] to the charity. Each card carries a unique 16-digit number that is catalogued electronically as “pending issuance” in the fulfillment system. Upon receipt confirmation [step 424], the cards are activated. The charity cards can either be batch activated immediately, batch activated on delay (i.e. to activate 24-hours later) or flagged as “held” until the Purchasing Group calls or electronically confirms receipt [step 426].

Upon receipt, the Charity places the already activated charity cards in their inventory and may begin marketing to their supporters [step 436]. Charities can market the charity cards in one of two ways: 1) purchased in advance as standard stock and fulfilled from inventory; or 2) purchased on demand by individual supporter orders. Typically, supporter orders are placed and payments are made through a central organization or Charity Coordinator 434, then the Charity submits bulk order and payment to the Charity Card Provider directly. In some charities, a single individual or a small staff may serve as a Charity Coordinator. In larger charities, a department having other responsibilities may perform the Charity Coordinator function. In either case, the Charity Coordinator will use traditional methods such as personal contact, telephone communications, and maintaining Web sites to solicit and provide services to the charity card users.

In either event, once payment is verified and the Charity receives the inventory, the cards are processed and broken into individual orders as indicated to the supporters [step 438]. Once received, the cards become the property of the user 442 and may be used at any merchant worldwide that accepts the branded card.

The Charity also keeps detailed records 440 of individual purchases of charity cards to track the funding represented by an individual, a family, and a group as a whole. Such records may also be used to trace cards by number for auditing as necessary from the government.

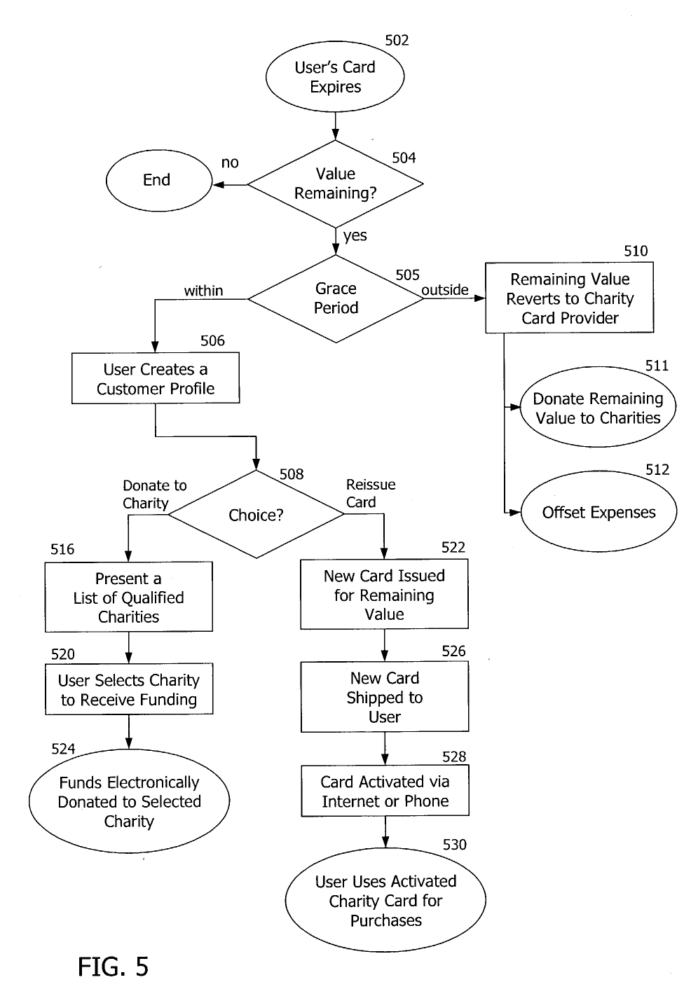

FIG. 5 reflects the process for handling expired funds on a user's charity card. A user can activate expired funds by proactively donating the expired funds to a charity of the user's choice or having the charity card reissued onto a new card with an extended expiration date. Once the card has reached the original expiration date 502, the user has the ability to access the remaining value [step 504] within an allotted grace period [step 505] using the Charity Card Provider's customer support systems, such support systems may include the Internet, phone support, or personal support. If the grace period has expired, the remaining value reverts [step 510] to the Charity Card Provider who may donate some or all of the remaining value to charities [step 511] and use the rest of the remaining funds, if any, to offset expenses [step 512].

Because the cards are issued anonymously, in order to reissue or donate remaining funds, the user must create a customer profile by providing identifying information [step 506]. The user may use the Internet to create the customer profile on the Charity Card Provider's web site or any other procedure established for this purpose. Once the profile has been created, the user may choose between donating the remaining funds to a charity or having a new card issued [step 508].

If the user chooses to donate the remaining funds, the user is provided with a list of charities qualified to receive the remaining funds [step 516]. The user then selects a charity [step 520] from the qualified charities list to receive the funds [step 524].

If the user chooses to have the remaining funds reissued, a new charity card will be reissued [step 522] and mailed directly to the user with a new and extended expiration date [step 526]. Once reissued to a user, the charity card must be activated via the telephone, the web site, or other available means [step 528] before use, and once activated, can be used at any accepting merchant worldwide [step 530].

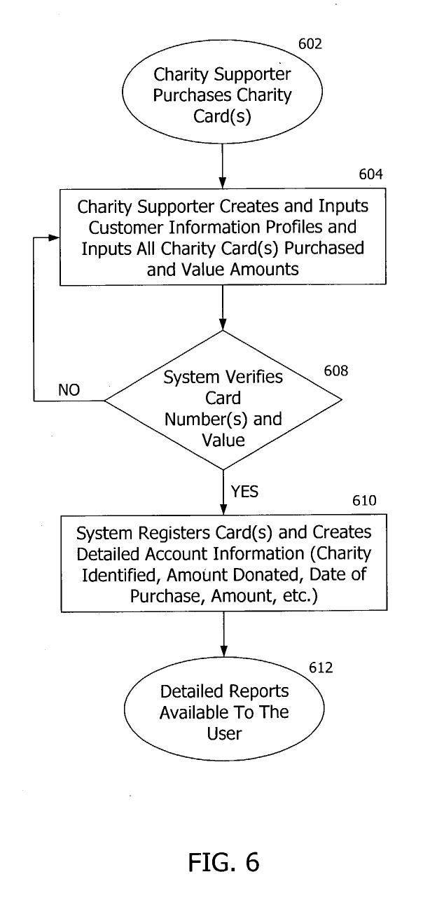

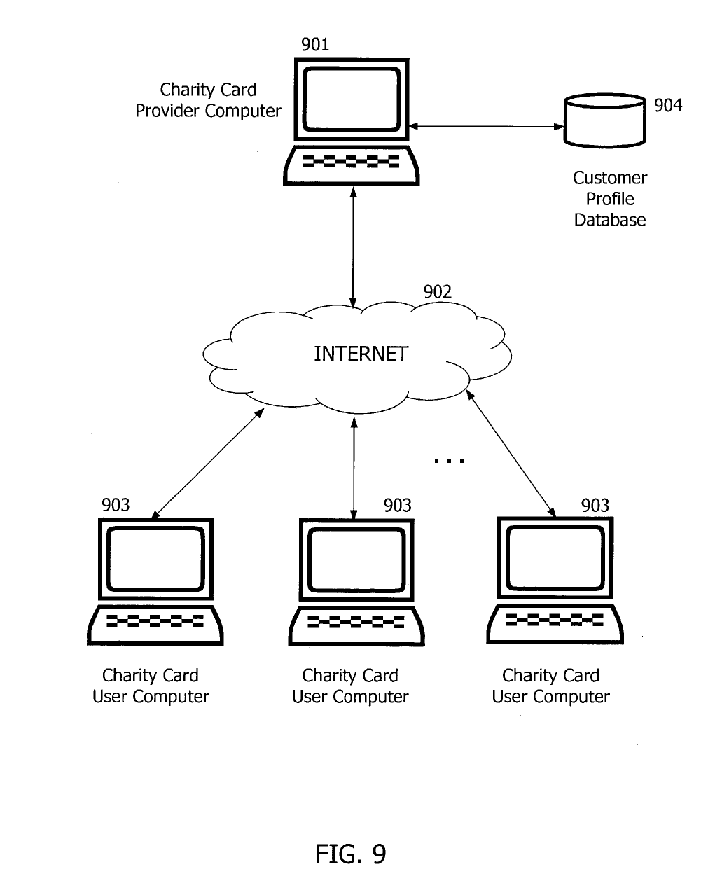

Referring now to FIG. 9, a user may communicate with the Charity Card Provider customer service using the Internet, telephone, or personal contact. The Charity Card Provider creates a web site to facilitate communication with users and operates computers and servers 901 connected to the Internet 902. Each user so desiring to communicate with the Charity Card Provider may do so by connecting the user's computer 903 to the Internet 902 and thereby establishing a communication path to the Charity Card Provider web site. Information may then be passed over this communication path to establish, for example, a customer profile that is stored on the customer profile database 904. A customer profile contains information necessary to track and prepare reports detailing a user's charity card purchase transactions as shown in FIG. 6.

FIG. 6 identifies a tracking/reporting system allowing users to track their total donations to a charity upon purchasing charity cards, and to receive a report detailing the donations and transactions. This report may be used for many purposes including documentation for income tax charitable deductions. Initially, the user 602 creates a customer profile [step 604] using the Charity Card Provider's customer support system. Because the cards are issued anonymously, the user must input the purchased card numbers into the customer profile individually. The system will verify the validity of the cards and the original issued values [step 608], and will then record and retain charity card purchase details such as the user name, address, total cards purchased, card numbers, total value donated, identified charities, dates of charity card purchases as well as merchant transaction details summarizing store locations, amounts, and dates of purchases [step 610]. A report of the charity card purchases 612 may be printed for use as documentation of charitable donations.

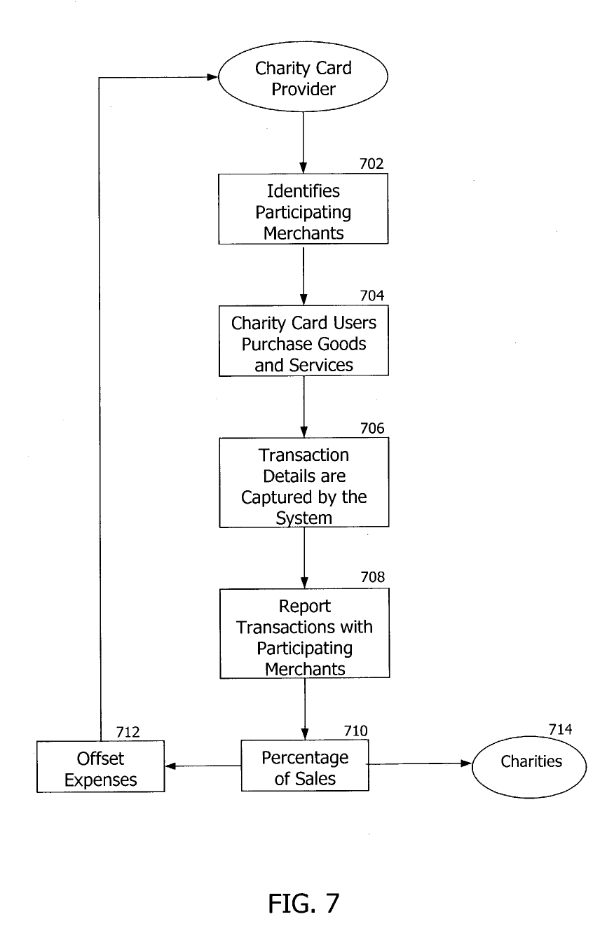

A separate channel of funding is shown in FIG. 7 wherein merchants may become associated with a charity or sponsor a charity funding program. In exchange for marketing and promotional services such as customized cards and card carriers, messages on the Charity Card Provider's web site, and printed material, merchants agree to provide a percentage of sales to the Charity Card Provider for use in offsetting promotional expenses or for providing additional funding to charities. The Charity Card Provider identifies merchants agreeing to participate in the program [step 702], and when the charity card is used at a participating merchant for goods or services [step 704], details of the transaction are captured [step 706]. The Charity Card Provider will then provide a report to each participating merchant detailing and summarizing the charity card users' transactions [step 708]. The report may provide details such as a user's affiliated charity and the purchasing channel used by the user such as a store location, catalog sales, or Internet purchase. The participating merchant then provides an agreed upon percentage of sales [step 710] for use by the Charity Card Provider to offset expenses [step 712], for direct remission to one or more Charities 714, or divided between the Charity Card Provider and one or more charities.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method for providing funding to a charity, said method comprising:
identifying a charity;
qualifying said charity, wherein said qualifying further comprises establishing a contractual agreement between a Charity Card Provider and the qualified charity, establishing a charity account portfolio, and establishing a customer database;
receiving an order and a first payment for a prepaid open-ended stored-value charity card from the charity in response to a user, the user providing a second payment to the charity, wherein the charity card has a prepaid value;
providing the charity card to the charity; and
distributing the charity card to a user,
wherein the charity retains the difference between the second payment and the first payment as said funding.

2. The method of claim 1, further comprising activating the charity card by the charity.

3. The method of claim 1, further comprising identifying a Reseller, wherein the Charity Card Provider enters into a contractual agreement allowing the Reseller to provide the charity card to the charity.

4. The method of claim 3, further comprising activating the charity card by the Reseller.

5. The method of claim 1, wherein the first payment provided by the charity is less than the prepaid value of the charity card.

6. The method of claim 1, wherein the second payment provided by the user is more than the prepaid value of the charity card.

7. The method of claim 1, wherein the charity card is embossed to identify a sponsoring merchant or charity.

8. The method of claim 1, wherein the charity card has an expiration date.

9. The method of claim 8, wherein the charity card has an initial value.

10. The method of claim 9, wherein the charity card may be used for a plurality of transactions, and wherein each successive one of the plurality of transactions decreases a remaining value on the charity card.

11. The method of claim 10, wherein the charity card has a remaining balance when the charity card expires.

12. The method of claim 11, wherein the remaining balance is donated to a qualified charity.

13. The method of claim 11, wherein the remaining balance is reissued as a new charity card.

14. The method of claim 11, wherein the remaining balance is retained by the Charity Card Provider.

15. The method of claim 1, further comprising creating a customer information profile.

16. The method of claim 15, wherein the customer information profile has charity card information.

17. The method of claim 16, wherein the charity card information comprises issuing charity, charity card purchase date, charity card amount, and charity card number.

18. The method of claim 15, wherein a report is provided to the charity card user.

19. The method of claim 18, wherein the report contains information for documenting charitable contributions.

20. The method of claim 18, wherein the report contains information of charity card transactions.
